(19) United States
(12) Patent Application Publication
(10) Pub. No.: US 2006/0057276 A1
(43) Pub. Date: Mar. 16, 2006

(54) Chewing gum or soft caramel and the production method thereof

(76) Inventors: Emilio Romero Carcasona, Sabadell (ES); Jose Angel Solana Mur, Sabadell (ES); Angel Palomes Royo, Sabadell (ES)

Correspondence Address: BELL, BOYD & LLOYD LLC, P. O. BOX 1135, CHICAGO, IL, 60690-1135, US

(21) Appl. No.: 10/492,725

(22) PCT Filed: Oct. 16, 2002
(86) PCT No.: PCT/ES02/00489

§ 371 Date: Jun. 17, 2005

(30) Foreign Application Priority Data
Oct. 16, 2001 (ES) P200102280

(51) Int. Cl. A23G 3/00

(52) U.S. Cl. 426/660

(57) ABSTRACT

The invention relates to chewing gum or soft caramel and the production method thereof. The inventive method consists in producing a continuous strand of a product comprising chewing gum or soft caramel, said strand being in the form of a channel. A sheet comprising a liquid product that gels in a reduced amount of time is deposited inside the channel. Said method can be used to produce individual units of said product by cutting the aforementioned compound strand. The sheet of gelled product is perfectly visible in each of said units as it remains on the surface of three of the sides of the chewing gum, said gum being laterally fixed to the sheet of gel in order to prevent the sheet from separating easily.

### BACKGROUND OF THE INVENTION

The present invention relates to a confectionary product and the production method thereof. More particularly, the present invention relates to a chewing gum or soft caramel in which a gel is superficially anchored, as well as its method of production in a continuous process.

Confectionary products composed of two differentiated parts, an internal and external part, have garnered popularity. The external part is composed of gum, a soft or hard caramel or another confectionary product capable of being extruded. Likewise, the internal part is composed of gum, gel, soft or hard caramel, or an effervescent product, in a solid, liquid, pasty or dusty condition, as the case may be.

Generally, the final product is obtained through the division into unitary pieces of a continuous strand formed by an external tube, and by the simultaneous introduction of the filler material into its interior.

To this end, the methods partly described in the U.S. Pat. No. 3,857,963, which consist of the extrusion of the outer product, in this case the gum, and in turn of the filler material, in this case the liquid, both of which would be initially located in two separate containers, will be used. The extrusion of the gum is undertaken through a nozzle, which concentrically bears a second nozzle through which the filler material is positioned inside the gum tube. Other patents related to similar proposals are U.S. Pat. No. 4,466,983 and U.S. Pat. No. 5,035,905.

In the Spanish patent no. 92011551, a gel-filled gum and the production method thereof are described. In this patent, the gel is the filler and it's only visible from the ends of each piece as a result of the cutting of the continuous strand into individual units.

The unitary pieces of this gum are characterized in that the fillers will remain occluded, given that the material mass contained inside will be either a liquid or a powder, or at most will be visible in the extremes of each piece as a result of the transversal cut of the continuous strand in each of the individual pieces.

Unlike the filler material for hard caramels, gum fillers should have a suppleness similar to that of the gum, given that its consumption entails that both parts be chewed and homogenized. Its industrial production differs substantially from the one applied to hard caramels, given the increased suppleness of the gum itself compared to the low flexibility of others.

Fillings in gums are oftentimes used in a dusty or liquid state. In both cases, it is not possible to use a continuous production, but rather a wrapping of individual units, which entails a temporal process longer than that required for the production of gums without fillers.

It may also be found that gums or other candies may be formed by two superimposed layers of different colors and/or flavors, which are essentially the same type of product (gum, gel or chewable caramel). The assembly or superimposition of layers is usually manual or achieved by double extrusion.

In order to produce jellified products, it is necessary to place a product in liquid state on moulds individually, leaving it to settle for a more or less prolonged period of time inside special acclimatization chambers for its jellification and drying.

Subsequently, it is necessary to elaborate each of the final pieces, starting with coating the whole of them with the gum itself.

The separate production of the aforementioned jellified filler does not allow for the production of gum through a continuous process with filler material or surface materials of this sort.

In concrete combinations of a solid covering and a solid filling, it is possible that the final product may be configured in such a way that the filler may be visible from the exterior. Gums formed through composites of the same matter, such as those described in the British Patent 2096447 B, and obtained by concentrically extruding two different masses of this product are quite popular. Caramels with similar characteristics are also popular. In all of them, however, the filler material can only be seen in the ends where pieces have been cut.

However, soft caramels or gums with a superficial sheet of gel fixed to the gum, with the said sheet of gel totally visible over every side of each piece, are unknown. Obviously, continuous production procedures for soft caramels or gums of these characteristics are not known either.

### SUMMARY OF THE INVENTION

The present invention relates to confectionary products. More specifically, the present invention relates to a confectionary product comprising a body of gum or soft caramel. The product includes channels that are so constructed and arranged that a gel contained in the channel is visible from the exterior of each of the pieces of the product from a plurality of sides. Preferably, the gel is visible on at least three sides of the piece. Methods of making the product are also provided.

Additional features and advantages of the present invention are described in, and will be apparent from, the following Detailed Description of the Invention.

### DETAILED DESCRIPTION OF THE PRESENT INVENTION

This invention relates to a gum or soft caramel, with a gel sheet covering one of its sides, completely visible from the exterior, and the production thereof through a continuous process. The gum or the soft caramel is obtained through the sectioning into pieces of a strand composed of a gum or soft caramel support, in which the gel has already been placed.

The final unitary product shows a sufficient and stable consistency, as it can be presented in several forms, with different flavor and color compositions.

The superficial sheet is comprised of a liquid product that jellifies in a reduced amount of time. This product is comprised of sugars, aromas, glucose syrup and other ingredients, including one or several jellifying agents such as starches, modified starches, agar-agar, pectins of high and low methoxyl index, carrageenans, gelatins or the like.

As will be described, the method used allows for the production of individualized units by forming a continuous channel of extruded gum or soft caramel, in which surface a gel has been placed. This production method consists of different stages: a separate preparation of the three constituents (mass of gum or soft caramel, a liquid solution between 93% to 95% and an acid solution between 0.5 to 7%), the extrusion of the gum or the soft caramel forming a channel, the pumping of the liquid solution and pumping of acid solution, and through a mixer, the deposition of the filler material and continuous processing.

The mass of the gum or soft caramel is conventional, and prepared in accordance with known procedures unrelated to those of the current invention.

The gel product is simultaneously prepared in liquid state by mixing a liquid solution with an acid one. The jellification of the filler material in its liquid state is achieved in a short period of time, thanks to this acidic additive and/or cooling to which is subsequently submitted.

While the mass of gum or soft caramel that forms the channel is being extruded, its surface receives the liquid and acid solutions by means of pumping through a static mixer, thus forming the sheet of gel in liquid form, remaining trapped in the surface of the channel of the gum or soft caramel.

In order to ease deposition and fixation of the gel sheet in the surface of the strand of the chewable gum or caramel, it is essential that said strand has a U-form section, and that the laterals of the said strand close completely on the laterals of the gel sheet. This will avert that, during the subsequent manipulation and cooling of the product, the gel sheet comes into contact with machines and, therefore, sticks to it.

More specifically, the nozzle of the extrusion of the gum or soft caramel has a determined form for the output of the product, allowing the channel of the gum or soft caramel to have a transversal section in the manner of a dovetail groove and its height should exceed that of the surface of the sheet of gel. That enables the gel sheet to be trapped against the channel of the gum or soft caramel, and besides that does not come into contact with, and therefore does not stick to, the different components of the production line where the continuous channel would pass until is cut into individual units and is wrapped.

The mixture of liquid and acid solution (which as a whole will form a liquid mass that will give rise to the gel) is pumped at a temperature higher than the one for gelification, the deposited liquid acquiring a definite consistency in gel shape in the surface of the aforementioned strand with a channel form, in a short period of time, by the reaction of the liquid solution with the acid solution and/or by the decrease of the temperature as a whole.

Thus, a continuous strand of a product composed of gum or soft caramel and a gel in the surface, is produced. Once the strand is cooled (as usually occurs during the production of gum) it may be divided into individual portions. In each of these portions the sheet of gel will be completely visible in three of the sides of the product.

### PRESENTLY PREFERRED FORMULATIONS OF THE INVENTION

By way of example and not limitation, examples of the products of the present invention will now be provided.

The following examples are based on a mass of gum or soft caramel, which in its surface may include a sheet from the liquid and acid solution.

A mass of gum may be composed of:

50 to 75% of ground sugar,

15 to 30% of base glue,

10 to 20% of glucose syrup,

0.2 to 2% of aromas, and

1 to 8% of glycerin.

This gum mass may also be comprised of up to 3% of citric acid and up to 1% of coloring matter.

The preparation of the same is conducted as follows. Part of the ground sugar, base glue and glucose syrup are mixed, at a temperature of 60 degrees Celsius, adding the coloring matter next, if any is available. The glycerin is then added, and in this case, the citric acid, the remaining ground sugar and finally the aroma. This mass will be ready to be extruded.

A soft caramel mass is comprised of:

20 to 40% of sugar,

20 to 40% of glucose syrup,

6 to 9% of water,

6 to 10% of fat,

0.1 to 3% of emulgent,

0.5 to 3% of gelatin,

0.01 to 2% of aromas.

This soft caramel mass may also be comprised of up to 5% of citric acid and up to 1% of coloring matter.

The preparation thereof is conducted as follows. Five percent of glucose syrup is mixed with 2% of water at 30 to 35 C. degrees. Then, gelatin is added until dissolved, increasing temperature up to 50-60 C. degrees.

The sugar, the remaining glucose syrup and the remaining water are mixed separately at a temperature of 120-135 C. degrees. Once it is ready, the mixture is cooled until it reaches 90 C. degrees.

The former mixture is added to this latter, along with the fat and emulgent, and once mixed, the preparation should be cooled at 60 C. degrees. Then, the aromas are added and once mixed, it should be allowed to settle for 8 hours at a temperature of 25 to 30 C. degrees.

A liquid solution is comprised of:

20 to 60% of sugar,

20 to 50% of glucose syrup,

0 to 15% of glycerin,

0.5 to 5% of HM pectins,

0.1 to 5% of sodium citrate

0.1 to 5% of citric acid,

0.01 to 2% of aromas.

This solution may also contain up to 1% of coloring matter.

The preparation thereof is conducted by dissolving the pectin, sodium citrate and citric acid in water at a temperature between 50 and 80 C. degrees, and the pectin should not be gelified or degraded.

The sugar, glucose syrup and the above preparation should be mixed separately, boiled in order to achieve a dried matter between 75% and 82%, so as to have a remaining proportion of water between 18 and 25%. Next, the glycerin, aroma and coloring agent, if any, are added.

An acid solution is comprised of:

40 to 90% of water,

10 to 60% of acid,

This solution may also be comprised of up to 2% of coloring matter.

The preparation thereof is conducted by mixing its components at a temperature of 15 to 25 C. degrees.

The mass of gum or soft caramel is prepared as indicated, and is placed in an output container, allowed to be pumped mechanically through an extruder which at one end has an output finished by a nozzle and is capable of continuously preparing a channel-shaped strand with a dovetail groove transversal section in order to ease subsequent gel obstructions by the lateral walls of said channel.

The liquid and acid solution is placed in two separate containers, afforded with an output conduit with an individual pump on each of them. The two pumps are connected to a static mixer.

The static mixer includes an output with a conduit (with a lower section than the nozzle which extrudes the gum mass or soft caramel). The output is flat-shaped and is located on the surface of the U-formed nozzle vale of the extruder.

The strand of the gum mass must have a channel form to receive the liquid mass that will subsequently gelify.

By extruding the gum mass, the gelifiable filler material will be deposited simultaneously, the latter invading almost the whole gorge of the chewable gum or caramel.

The inclusion of the organic acid in the composition of the filling will cause the pectin with a high index of methoxyl to gelify in a short period of time. This period depends mainly on the quantity of added organic acid, the concentration of the indicated pectin and the general temperature of the solution during and after the addition of the organic acid.

Specifically, the gelification time is reduced noticeably by decreasing the static mixer's output temperature, so that adjustments to the added quantity of organic acid, the length of the output conduit, or the temperature of extrusion of the mass of the gum or soft caramel, among other factors, it may be possible to get the solution to gelify on the surface of the mass of the gum or soft caramel.

A similar process may be used if pectin with low index of methoxyl is used. In this case, gelification is achieved through the use of an aqueous solution of calcic salt with a high concentration of Ca++ divalent ions A second formulation to obtain a preparation fit to be used as a surface sheet with similar characteristics to the one described above may consist of a solution of sugar, syrup and aromas with a gelifying agent such as agar-agar, carrageenan, starches or gelatins, or mixtures thereof.

This solution is kept hot, above the temperature of gelification, in the static mixer, until it is deposited simultaneously while extruding the strand of the gum or soft caramel.

A decrease in the temperature of the output conduit of the mixer allows the cooling of the solution to achieve its gelification once it is on the surface of the gum mass strand.

The cooling of the strand, once the whole has been produced, allows the whole to be processed.

Percentages of the mass of gum or soft caramel and the gelifiable sheet with respect to the final product vary, and the strand base and its lateral walls should have enough resistance to support the gelifiable sheet and preclude its spreading before gelification is achieved. The minimum percentage of mass of the gum or soft caramel should be at least 40% of the total product comprised of the gum or caramel and gelifiable mass.

Regardless of the type of gelifiable mass used, the result is a gum or soft caramel channel full of gelified product, a whole capable of being sectioned in individual units, one of the major sides of each piece showing the jellified sheet and the superficial parts of the wall of the gum or soft caramel channel. In the opposite side and the lateral sides only the chewable gum or caramel are visible. And, finally, in both sides of the individual pieces cut, chewable gum or caramel as well as a gelified sheet are visible.

The resulting confectionary product (gelled gum or soft caramel) and its respective method of production may be essentially modified with respect to its accidental characteristics by an specialist in the field without modifying the essence of the invention that will be explained in the following claims.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-15. (canceled)

16. A confectionary product comprising a body formed by a composition chosen from the group consisting of soft caramel and gum, the body defining a channel including a gel, the gel being so located in the channel so as to be visible from an exterior of the product on three sides of the product.

17. The confectionary product of claim 16, wherein the product is prepared through a process that entails a sectioning in pieces of a continuous strand of the composition in a hollow full of gel.

18. The confectionary product of claim 16, wherein two of the three sides are opposite from each other.

19. The confectionary product of claim 16, wherein the gel is located on at least one surface of the product.

20. The confectionary product of claim 16, wherein the gel comprises up to 60% of the total volume of the product.

21. The confectionary product of claim 17, wherein the strand has a transversal section in a U form, and the laterals of said strand close upon the laterals of the gel sheet.

22. The confectionary product of claim 21, wherein the continuous strand has a transversal section in a dovetail groove form.

23. The confectionary product of claim 17, wherein the product has a regular geometrical shape.

24. The confectionary product of claim 16, wherein the gel comprises a colour that is different than the composition.

25. The confectionary product of claim 16, wherein the gel has a flavour different than a flavour of the composition.

26. A method of producing a confectionary product comprising the steps of:
preparing a gum or soft caramel mass, a liquid solution and an acid solution;
placing of the three components in separate containers;
separately pumping the liquid and acid solution into a static mixer;
extruding the soft caramel and gum mass through a nozzle forming a continuous strand in a U-shaped transversal section channel;
placing in the channel interior the liquid and acid solution of the mixture, in a liquid state; and
refrigerating a resultant continuous strand in a form of a superficial sheet until the gelification of the liquid and acid solution.

27. The method of claim 26, comprising the step of gelification of the liquid and acid solution inside the channel.

28. The method of claim 26, comprising the step of causing said continuous strand to have a transversal section in a dovetail groove form.

29. The method of claim 26, comprising the step of providing a gelification time that is less than the time necessary for the proper cooling of the strand of soft caramel or gum.

30. The method of claim 26, comprising the step of forming the strand into individual pieces by sectioning the strand in portions.

31. A confectionary product comprising a gum body including a channel including a gel, the gel being so constructed and arranged in the channel so as to be visible from the exterior of the product on at least three sides of the product.

32. The confectionary product of claim 31, wherein the gel comprises up to 60% of the total volume of the product.

33. A confectionary product comprising a soft caramel body including a channel including a gel, the gel located in the channel so as to be visible from the exterior on at least three sides of the product.

34. The confectionary product of claim 33, wherein the gel comprises up to 60% of the total volume of the product.
